(19) United States
(12) Patent Application Publication
(10) Pub. No.: US 2025/0243960 A1
(43) Pub. Date: Jul. 31, 2025

(54) DUST-SHIELD DEVICE FOR HYDRAULIC FITTINGS AND HYDRAULIC CONNECTION ELEMENT

(71) Applicant: Parker Hannifin EMEA S.à.r.l., Etoy (CH)

(72) Inventors: David ARAGONES, Sciez (FR); Fabrice TARISSAN, Villaz (FR)

(73) Assignee: Parker Hannifin EMEA S.à.r.l., Etoy (CH)

(21) Appl. No.: 18/851,109

(22) PCT Filed: Mar. 28, 2023
(86) PCT No.: PCT/EP2023/058015

§ 371 Date: Sep. 26, 2024

(30) Foreign Application Priority Data
Mar. 28, 2022 (FR) FR22/02759

(51) Int. Cl. F16L 55/10; F16L 55/24

(52) U.S. Cl. CPC F16L 55/1018; F16L 55/24

(57) ABSTRACT

The invention relates to a dust-shield device for a hydraulic connection to which a hydraulic socket can be connected and disconnected, comprising: a body provided with a bushing designed to be inserted onto said hydraulic fitting, a cap rotatable between a closed position for protecting said hydraulic fitting in its disconnected state and an open position for accessing said hydraulic fitting in its connected state; and a spherical head attached to a lower end of the body and a chute connected the spherical head by a ball-joint connection; and a channel formed in the body extending from the bushing to the spherical head.

### TECHNICAL FIELD

The present invention relates to a dust-shield device for protecting a hydraulic connection and to a hydraulic connection element equipped with a dust-shield device.

### PRIOR ART

In many industrial sectors, such as agricultural machinery, connecting equipment hydraulically to a hydraulic system using standardized fittings, is a standard practice.

In practice and in the specific case of agricultural machinery, a tractor is equipped on its rear end with one and generally several quick hydraulic connectors onto which additional hydraulic connector snaps. This creates a hydraulic connection that ensures leak-free passage of hydraulic fluid and supplies hydraulic power to the equipment (trailer, plow, seeder, etc.).

Due to their position, the fittings are exposed to dirt such as mud, rain, dust, etc. They are therefore protected by dust-shield devices which include rotating movable caps to provide access to the fittings and protect the fittings from dirt when not in use.

Dust-shields perform another important function, which is the collection of fluids that inevitably escape from the fittings during connection and disconnection operations. It is important to collect these fluids so that they do not contaminate the soil. For this purpose, dust-shield devices include channels which ensure the collection of fluids and then convey them by gravity through a flexible pipe to a tank, as shown for example in document DE-U-8508621. The tank itself is emptied periodically.

However, the hydraulic connections and the fluid collection tank configurations differ from one vehicle to another as concerns their locations. The consequence is that each vehicle must be equipped with its own dust-shield device, in particular to ensure the connection with the tank.

These issues of protecting hydraulic connections do not arise exclusively in the field of agricultural machinery but concern, for example, public works machinery.

### PRESENTATION OF THE INVENTION

In this technical context, one aim of the present invention is to improve the management of connection and disconnection fluids of hydraulic fittings.

Another aim of the invention is to provide a dust-shield device which can be installed on different types of vehicles regardless of the location of the hydraulic connector(s) and the associated fluid collection tank.

Another aim of the invention is to provide a hydraulic connection element which can be installed on different types of vehicles regardless of the location of the hydraulic connector(s) and the associated fluid collection tank.

Primarily, the present invention's first aspect relates to a dust-shield device for a hydraulic connection to which a hydraulic socket can be connected and disconnected, said device comprising:
a body equipped with a socket designed to engage on said hydraulic connection, a cap movable in rotation between a closed position for protecting said hydraulic connection in its disconnected state, and an open position for accessing said hydraulic connection in its connected state, and
a spherical head attached to a lower end of the body and a chute connected to the spherical head by a ball joint, and
a channel in the body extending from the socket to the spherical head.

The invention thus provides a dust-shield device which has an adjustable chute which can be oriented according to the respective positioning of a hydraulic connection and a tank for collecting oil for connecting/disconnecting said connection. In other words, the dust-shield device can be configured to suit any type of fitting and oil collection tank layout.

According to other provisions of the invention taken alone or in combination:
the chute includes a cup that snaps onto the ball head.
the cup has an opening whose plane forms an acute angle with the X axis of the chute.
the cup has on its internal face a first spherical zone which surrounds the opening of the cup defined by a first radius which is equal, apart from the operating clearance, to the radius of the spherical head, and a second spherical zone which is located at the junction of the cup and the flow chute which is defined by a second radius greater than the radius of the first spherical zone.
the device includes a blind top cover.
the device comprises a lower cover on which the spherical head is attached.
the device comprises a base module which includes a body portion on which the socket is fixed, the cap fixing yoke and a channel portion.
the device comprises a connecting spacer provided with a means for interlocking designed to connect two base modules.

The invention's second aspect relates to a hydraulic connection element comprising a housing in which is arranged at least one hydraulic connector configured to be connected and disconnected to a coupler. This hydraulic equipment is characterized by and comprises a movable cap between a closed position for protecting said hydraulic connector in its disconnected state and an open position for accessing said hydraulic connector in its connected state. Equally an annular cavity surrounding the connection end of said hydraulic connector, an insert having a spherical head on which a chute is engaged, the insert hydraulically connecting said annular cavity to the chute.

As regards different features that can be implemented independently and combined:
the hydraulic connection element comprises at least two hydraulic couplers and a collection channel which connects the two adjacent coupler annular cavities.
the hydraulic connection element comprises a chamber in which are arranged means for controlling the coupler(s) and an insert having a spherical head on which a chute is engaged, the insert hydraulically connecting said chamber to the chute.
the chute includes a cup that snaps onto the ball head.
the cup has an opening whose plane forms an acute angle with the X axis of the chute.
the cup has on its internal face a first spherical zone which surrounds the opening of the cup defined by a first radius which is equal, apart from the operating clearance, to the radius of the spherical head, and a second spherical zone which is located at the junction of the cup and the flow chute which is defined by a second radius greater than the radius of the first spherical zone.

### BRIEF DESCRIPTION OF THE APPENDED FIGURES

Other characteristics and advantages of the present invention will become apparent on reading the description which follows and on examining the appended figures in which:

FIG. 1 is a perspective view of a dust-shield device 1;

FIG. 2 is a frontal view of the dust-shield device 1;

FIG. 3 is a section view according to section plan A-A of FIG. 2;

FIG. 4 is an enlarged scale view of the lower portion of the dust-shield device 1;

FIG. 5 is a section view according to section B-B of FIG. 3;

FIG. 6 is a schematic view of a dust-shield device 1 installed on a vehicle;

FIG. 7 is a view showing a flow chute in a first orientation;

FIG. 8 is a view showing the flow chute in a second orientation;

FIG. 9 is a view showing the flow chute in a third orientation;

FIG. 10 is a perspective view of a hydraulic connection mechanism;

FIG. 11 is an enlarged scale and sectional view of a chute;

FIG. 12 is a section view of the hydraulic connection mechanism of FIG. 10.

### DESCRIPTION OF THE INVENTION

In its embodiment illustrated in the figures, the dust-shield device 1 is designed to ensure the protection of two so-called quick connectors 50, a schematic example of which can be seen in FIG. 6. The connectors 50 are themselves fixed to a machine 60 such as a tractor or an agricultural machine, public works machines or other. It is specified that, by dust, we mean in the generic sense all types of dirt such as mud, rain, foreign bodies likely to settle on a 50 connector and hinder its operation.

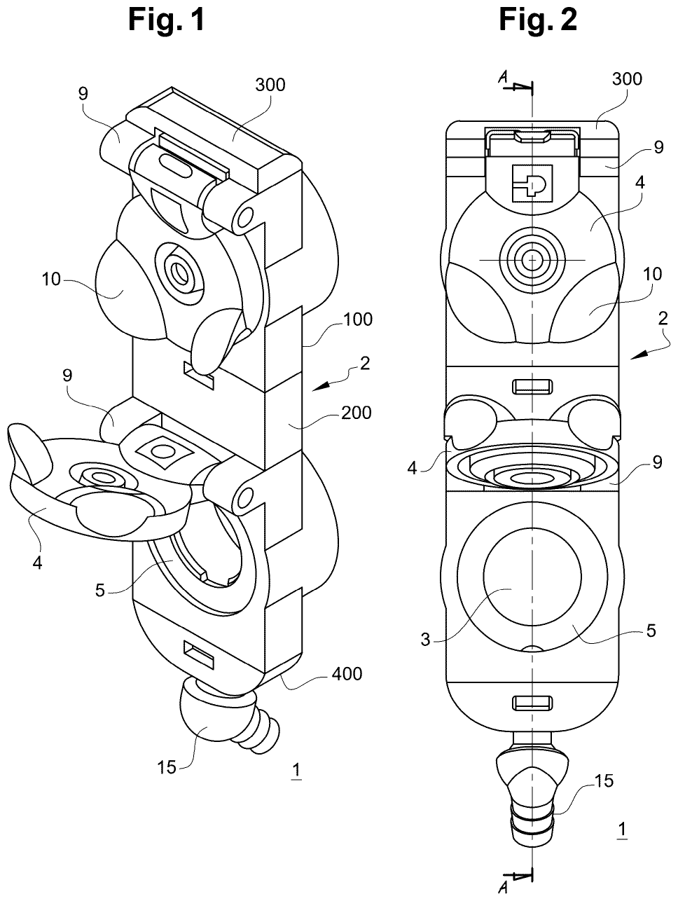

With particular reference to FIGS. 1 and 2, the dust-shield device 1 comprises a body 2 of generally elongated shape having an internal face which is intended to be engaged with the connectors 50 and an external face opposite the internal face.

In the present exemplary embodiment, the body 2 comprises two circular openings 3 which are, by convention, identified as upper opening 3a and lower opening 3b. As we will see later, the dust cover device is designed to be oriented vertically.

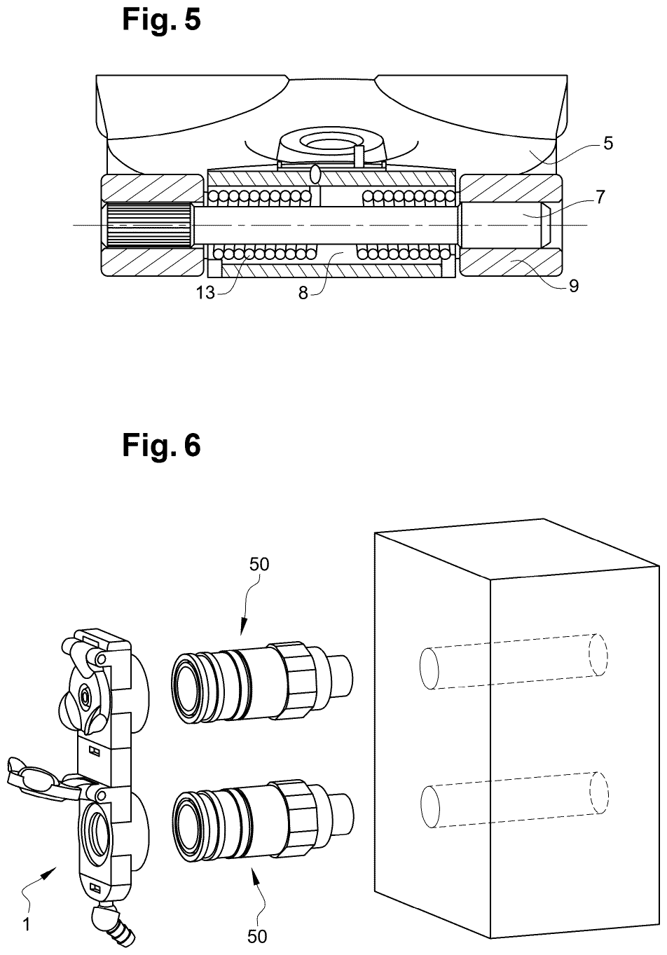

On the external face of the body 2, there are two pivoting caps 4 which each close the circular opening 3 made in the body 2. A joint 5 can be arranged around opening 3. As can be seen in FIG. 5, each cap 5 is connected to the body by means of an axis 7 which is engaged both in a bore 8 made in the cap 5 and in a yoke 9 made in the body. A hairpin spring 13 is mounted coaxially with the axis interposed between the cap 5 and the body 2 so as to hold the cap 5 in the closed position. Each of the caps 5 is provided with two ears 10 which allow a user to come and exert a grip in order to pivot it towards an open position, thereby opposing the action of the spring 13.

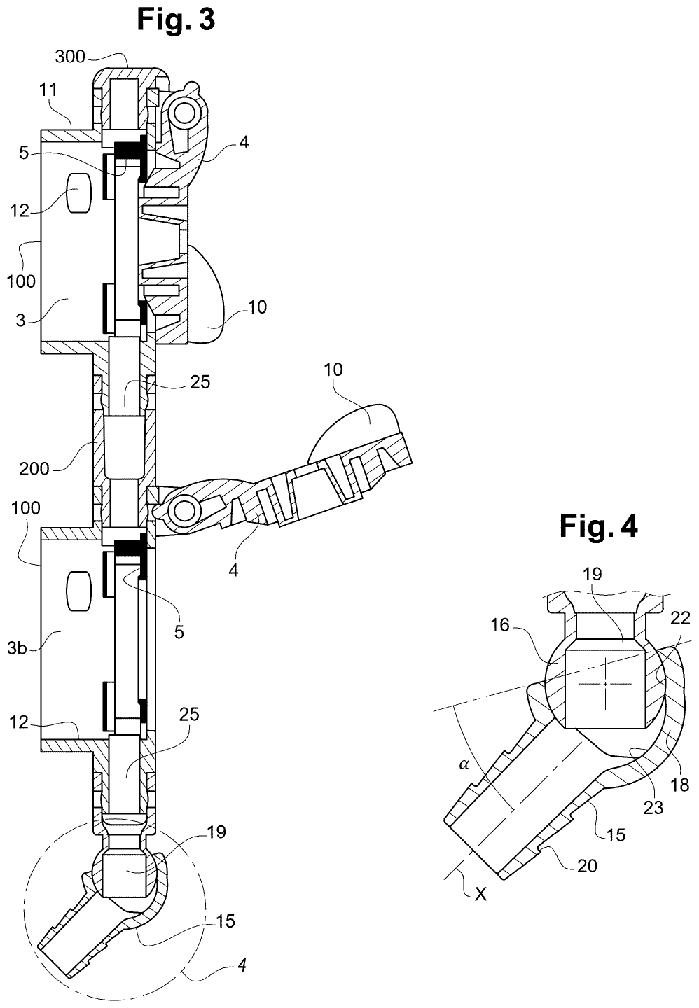

On the internal face, the body 2 comprises two circular sockets 11 which are positioned on the body 2 to surround the two openings 3. As can be seen in FIG. 3, each socket 11 is provided on its internal face with three bosses 12 arranged at 120° which allow an elastic snap-fit type fitting of the body 2 on a hydraulic connector 50.

At its lower end, the body 2 receives an adjustable flow chute 15. The connection between the flow chute 15 and the lower part of the body is of the ball joint type. For this, the body 2 is provided with a hollow spherical head 16 on which the flow chute 15 is engaged. For this purpose, the flow chute 15 is provided with a cup 18 which engages on the spherical head 16. In practice, the flow chute 15 is made of plastic so that the cup 18 can snap into place on the spherical head 16. The respective dimensions of the spherical head 16 and the cup 18 allow an adjustment which in turn allows the cup 18 to slide on to the spherical head 16, thus creating a ball joint which allows the flow chute 15 to be oriented in multiple directions. The spherical head 16 includes a bore 19 which opens into the flow chute 15.

The flow chute 15 can be provided on its outer face with retaining ribs 20 on which a flexible hose (not shown) can be engaged. The flexible hose itself is connected to a reservoir into which the hydraulic fluids from the connection and disconnection of the fittings flow by gravity.

In the example illustrated in the figures, the cup 18 which snaps onto the spherical head 16 has an asymmetry relative to the longitudinal axis X of the flow chute 15. In practice, the cup 18 may have an opening which defines a plane intersecting with the longitudinal axis of the flow chute 15 at an acute a angle which may be between 25° and 45° and be, for example, of the order of 30°. As can be seen in FIG. 4, the cup 18 has on its internal face a first spherical zone 22 which surrounds the opening of the cup 18 defined by a first radius which is equal, apart from the operating clearance, to the radius of the spherical head 16. Equally a second spherical zone 23 which is located at the junction of the cup 18 and the flow chute 15, which is defined by a second radius greater than the radius of the first spherical zone.

It is also noted that the body 2 incorporates a channel 25 for collecting connection/disconnection fluids.

FIG. 3 can be used to appreciate the structure and path of channel 23. This channel is provided in the thickness of the body 2 and runs along the entire length of the dust-shield device 1. Channel 25 thus connects the upper opening to the lower opening and the lower opening to the flow chute 15.

In the example shown in the figures, the dust-shield device 1 has a modular structure formed by elements that can be assembled.

In practice, the dust-shield device 1 may comprise a base module 100 which may be obtained by plastic injection. This base module 100 includes a body portion 2 on which the socket 11 and the cap fixing yoke 5 are fixed. The base module 100 also includes a channel portion 25.

A connecting spacer 200 is provided which allows two adjacent base modules to be connected. The connecting spacer 200 is itself provided with a passage which forms a portion of channel 25.

Also provided is a blind upper cover 300 to seal the device at its upper end and a lower cover 400 which receives the spherical head 16. The lower cover 400 is provided with a channel portion 25 which ensures fluid continuity from the upper base module and which opens out from the spherical head 16.

The connection of the various elements of the dust-shield device 1 is carried out by a system of male/female sockets with which the base modules 100, connecting spacer 200, upper cover 300 and lower cover 400 are provided.

In the example shown in the figures, the dust-shield device 1 comprises two basic modules but, depending on the configuration of the connectors 50 which are to be protected, it is possible to provide from 1 to any number of basic module(s) 100.

In particular, FIG. 6 shows a device intended to protect two hydraulic connections 50.

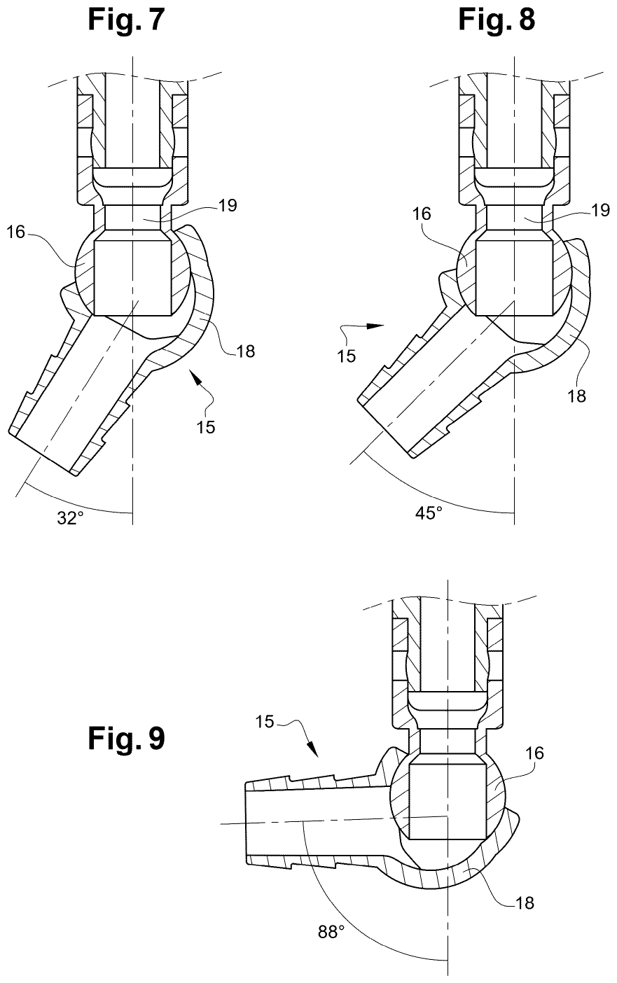

FIGS. 7 to 9 illustrate the angular amplitude that the flow chute 15 can take, which allows the dust-shield device 1 according to the invention to adapt to vehicles whose tank is positioned at different locations relative to the hydraulic connectors 50.

In other words, dust-shield devices are a standard element that can be fitted to a wide variety of vehicles, particularly agricultural vehicles, regardless of the position of the 50 hydraulic connections and the relative position of the connection/disconnection fluid collection tank.

According to another aspect, the present invention relates to a hydraulic coupling assembly 500.

The connecting element comprises a housing 501 which may be, for example, a casting. The housing 501 may have a vertically oriented parallelepiped shape. The housing may be provided with 502 holes on its rear face to ensure its attachment, for example, to an agricultural machine or to a public works machine.

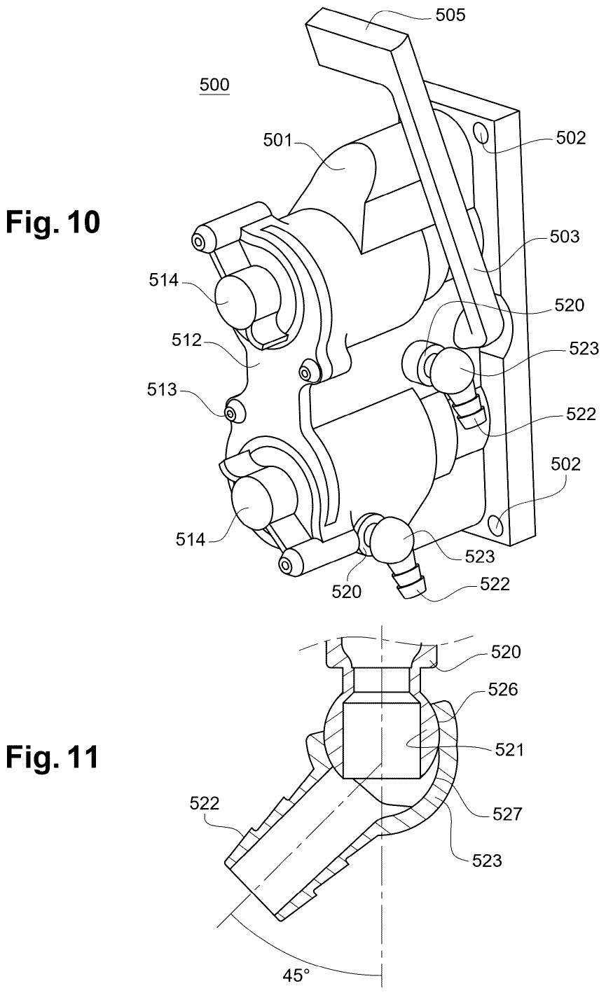

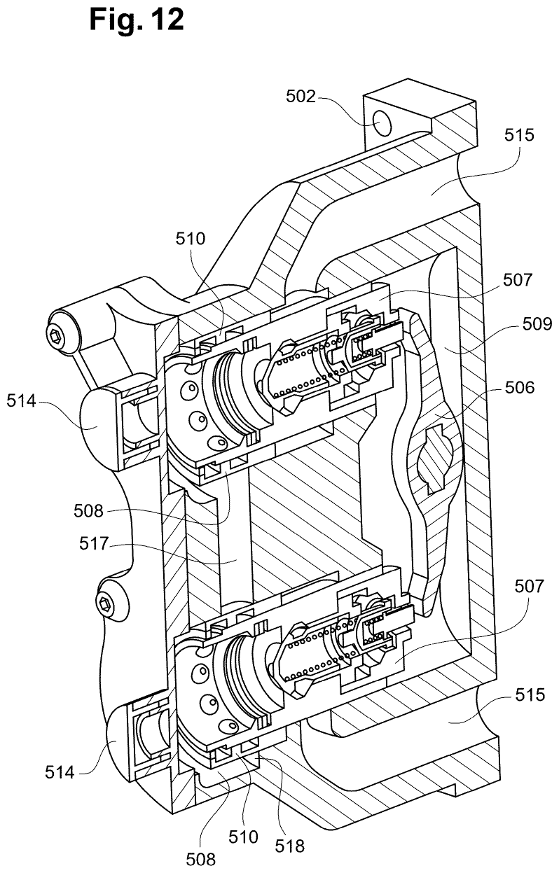

In the embodiment shown in FIGS. 10 and 11, the connection element receives two quick connectors 507. These are female quick connect couplings that are axially movable between a coupling position in which a male coupler (not shown) is hydraulically connected to a female quick connect to allow fluid flow and a release position in which the male coupler can be released.

In the example illustrated in FIGS. 10 and 11, the couplers 507 are actuated by a lever 503 which has a handle portion 505 which is external to the housing 501 and an arm portion 506 which extends from the lever 503 inside the housing 501 into a chamber 509. This is a non-limiting means of controlling the couplers 507; other control means can be envisaged.

Each of the quick connectors 507 is inserted into a housing made in the casing 501 and opens onto the front face of the casing 501. The connecting end of the couplers 507 is placed in an annular cavity 508. A 510 socket engaged on the connection end of each 507 connector acts as a bearing.

On its front face, the connection element receives a plate 512 which is fixed by screws 513. The plate 512 which can be made of plastic supports two pivoting caps 514 which are arranged opposite a quick connector 507 to close access to it and ensure protection when they are not in use.

The casing 501 is provided with supply channels 515 which bring the hydraulic fluid from a pump to the quick connectors 507 which, depending on the state of each, allow the hydraulic fluid to pass through or retain it.

Also noted is the presence of a collection channel 517 which extends between the two annular cavities 508.

At the lower connection, the casing is provided with a bore 518 which opens into the annular cavity 508 which, by gravity, collects the hydraulic fluids coming from the connection and disconnection of the connections 507 with male couplers.

A 520 threaded insert is screwed into the 512 bore. As shown in section in FIG. 11, the insert 520 is further provided with a pierced spherical head 521 on which a chute 522 is fixed. The connection between the spherical head 521 and the chute 522 is made for a cup 523 which engages on the spherical head 521 by snap-fastening. The ball joint thus created allows multi-directional orientation of the chute 522 relative to the casing 501.

It may also be planned to provide the chamber 509 in which the arm is placed with a bore into which a threaded insert 520 identical to that which allows the hydraulic fluid from the annular cavity 508 to flow is screwed.

The flow chute 522 may be provided on its outer face with retaining ribs onto which a flexible hose (not shown) may be engaged. The flexible hose itself is connected to a reservoir into which the hydraulic fluids from the connection and disconnection of the fittings flow by gravity.

In the example illustrated in the figures, the cup 523 which snaps onto the spherical head 521 has an asymmetry relative to the longitudinal axis of the flow chute 522. In practice, the cup 523 may have an opening which defines a plane intersecting with the longitudinal axis of the flow chute 15 at an acute angle a which may be between 25° and 45° and be, for example, of the order of 30° in the same way as that shown in FIG. 4.

The cup 523 has on its internal face a first spherical zone 526 which surrounds the opening of the cup 18 defined by a first radius which is equal, apart from the operating clearance, to the radius of the spherical head 521. Equally, a second spherical zone 527 which is located at the junction of the cup 523 and the flow chute 522 which is defined by a second radius greater than the radius of the first spherical zone 526.

In this second aspect, the invention makes it possible to orient the connection fluids in multiple directions and therefore to adapt to varied architectures of agricultural or other vehicles.

1. A dust-shield device for a hydraulic connector to which a hydraulic socket can be connected and disconnected, comprising:
a body equipped with a socket designed to engage on said hydraulic connector, a cap movable between a closed position for protecting said hydraulic connector in its disconnected state and an open position for accessing said hydraulic connector in its connected state, and
a spherical head attached to a lower end of the body and a chute connected to the spherical head by a ball joint, and
a collection channel provided in the body extending from the socket to the spherical head.

2. The dust-shield device according to claim 1, characterized in that the chute comprises a cup which engages on the spherical head by snap-fastening.

3. The dust-shield device according to claim 2, characterized in that the cup has an opening whose plane forms an acute angle with the axis X of the chute.

4. The dust-shield device according to claim 2, characterized in that the cup has on its internal face a first spherical zone which surrounds the opening of the cup defined by a first radius which is equal, apart from the operating clearance, to the radius of the spherical head. Equally a second spherical zone which is located at the junction of the cup and the flow chute which is defined by a second radius greater than the radius of the first spherical zone.

5. The dust-shield device according to claim 1, characterized in that the device comprises a blind upper cover.

6. The dust-shield device according to claim 1, characterized in that the device comprises a lower cover on which the spherical head is attached.

7. The dust-shield device according to claim 1, characterized in that the device comprises a base module which includes a body portion on which the socket, the cap fixing yoke and a channel portion are fixed.

8. The dust-shield device according to claim 7, characterized in that the device comprises a connecting spacer provided with fitting means designed to connect two base modules.

9. A hydraulic connection element comprising a casing in which is arranged at least one hydraulic connector configured to be connected and disconnected to a coupler characterized in that the hydraulic equipment comprises a cap movable between a closed position for protecting said hydraulic connector in its disconnected state. Equally, an open position for accessing said hydraulic connector in its connected state, and an annular cavity surrounding the connection end of said hydraulic connector, an insert having a spherical head on which a chute is engaged, the insert hydraulically connecting said annular cavity to the chute.

10. The hydraulic connection element according to claim 9, characterized in that the hydraulic connection element comprises at least two hydraulic couplers and a collection channel which connects the two annular cavities of adjacent couplers.

11. The hydraulic connection element according to claim 9, characterized in that the hydraulic connection element comprises a chamber in which are arranged means for controlling the coupler(s) and an insert having a spherical head on which a chute is engaged, the insert hydraulically connecting said chamber to the chute.

12. The hydraulic connection element according to claim 9, characterized in that the chute comprises a cup which engages on the spherical head by snap-fastening.

13. The dust-shield device according to claim 12, characterized in that the cup has an opening whose plane forms an acute angle with the axis X of the chute.

14. The dust-shield device according to claim 12, characterized in that the cup has on its internal face a first spherical zone which surrounds the opening of the cup defined by a first radius which is equal, apart from the operating clearance, to the radius of the spherical head. Equally, a second spherical zone which is located at the junction of the cup and the flow chute which is defined by a second radius greater than the radius of the first spherical zone.
